(19) United States
(12) Patent Application Publication
(10) Pub. No.: US 2008/0287993 A1
(43) Pub. Date: Nov. 20, 2008

(54) Pacifying Apparatus

(76) Inventor: David Goodwin, Surrey (GB)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 12/094,809

(22) PCT Filed: Nov. 27, 2006
(86) PCT No.: PCT/GB2006/004416

§ 371 Date: Jul. 16, 2008

(30) Foreign Application Priority Data
Nov. 25, 2005 (GB) 0524040.3

(51) Int. Cl. A61J 17/00

(52) U.S. Cl. 606/236

(57) ABSTRACT

A pacifier comprises a nipple and a supporting surface, the nipple being attached to and protruding from a first side of the nipple supporting surface, characterized in that pacifier is arranged to releasably interlock with at least one like pacifier.

### BACKGROUND OF THE INVENTION

### Field of the Invention

The present invention relates generally to apparatus for pacifying infants, and more particularly to a pacifier that is arranged to releasably interlock with other like pacifiers.

A pacifier comprises a nipple (a substantially teat-shaped protrusion) of rubber, plastic, etc., and is given to an infant to suck as a comforter. For example, a pacifier may be given to an infant to prevent it from crying. A pacifier is also known as, amongst other things: a soother, a comforter, and a dummy.

Pacifiers are fairly ubiquitous, and are often seen as an essential tool in the raising of an infant. It is not uncommon for the parent(s) or caregiver(s) of an infant to have in his/her/their possession a plurality of pacifiers. Having such a plurality of pacifiers has associated disadvantages.

For example, it is may be necessary to keep a box or an area for the storage of pacifiers. This may be unsightly, result in the consumption of an unnecessary amount of space in, for example, a nursery or kitchen environment, and, perhaps most importantly, be unhygienic. Also, when not in use, having the nipple of the pacifier exposed to the environment is not desirable. Particulate and chemical contaminants may accumulate on the surface, or even within the constituent material of the nipple. At best, this requires a parent or caregiver of the infant to continually clean the nipple of the pacifier prior to passing to an infant for use. At worst, an infant may suffer discomfort or infection from the contaminants.

From a commercial perspective, it is often desirable to minimize the amount of space taken up by a product, be it for storage or presentation and sale purposes; pacifiers are no exception. Furthermore, the presentation of a product plays a large part in its salability. Being irregular in shape, it is often difficult to efficiently package and present pacifiers, without the use of excessive and often unsightly packaging. It is thus an object of the present invention to obviate or mitigate at least one of the above-mentioned disadvantages.

### SUMMARY OF THE INVENTION

According to a first aspect of the present invention, there is provided a pacifier, comprising a nipple and a supporting surface, the nipple being attached to and protruding from a first side of the nipple supporting surface; characterized in that the pacifier is arranged to releasably interlock with at least one like pacifier.

The inventors have realized that in providing such a pacifier, a plurality of pacifiers can be interlocked with one another in a simple yet efficient manner. For example, the pacifiers may be stackable, which allows easy storage, packaging and display of the pacifiers. Alternatively, the pacifiers may be formed in such a way that, when interlocked, they form a closely packed and space saving set, again permitting easy storage, packaging and display. It is also envisaged that pacifiers of the present invention may be disposable and replaceable by a further pacifier from an interlocked stack or nest of pacifiers.

Most preferably, the pacifier further comprises a receptacle for receiving the nipple of a like pacifier. Preferably the receptacle protrudes from a second side of the nipple supporting surface, the second side being on an opposite side of the nipple supporting surface to the first side.

Preferably, the receptacle defines an inner receptacle surface arranged to receive the nipple of the like pacifier. Preferably, the inner receptacle surface is arranged to provide a push-fit arrangement with a nipple of a like pacifier. Preferably, the inner receptacle surface has dimensions corresponding substantially to the outer dimensions of the nipple of the like pacifier. The inner receptacle surface may be tapered.

Preferably, the inner receptacle surface is shaped such that the inner surface is arranged to completely envelope the nipple of the like pacifier when interlocked therewith. Most preferably, the nipple supporting surface comprises at least one aperture arranged to receive a nipple of the like pacifier.

Preferably, the nipple is located on the periphery of and depends from a first side of the nipple supporting surface.

Preferably, the at least one aperture is located on the periphery of the nipple supporting surface.

Preferably, the pacifier further comprises a guide element, arranged to ensure a specific relative orientation of the pacifier and a like pacifier when releasably interlocked therewith. Preferably, the guide element protrudes from a second side of the nipple supporting surface, the second side being on an opposite side of the nipple supporting surface to the first side. Preferably, the guide element is located substantially in the center of the nipple supporting surface.

Preferably, the pacifier further comprises a guide recess arranged to receive the guide element of the like pacifier. Preferably, the guide recess is formed in the first side of the nipple supporting surface. Preferably, the guide recess is located in the center of the nipple supporting surface.

Preferably, the guide element has outer dimensions that substantially correspond to the inner dimensions of the guide recess.

Preferably, the at least one aperture is shaped to receive a guide element of the like pacifier.

Preferably, the nipple supporting surface is shaped such that, in a location diametrically opposed to the nipple, there is an indent in the circumference of the supporting surface. Preferably, the nipple supporting surface is substantially disc-shaped.

The pacifier may be made as a single piece of material.

According to a second aspect of the present invention, there is provided a method of manufacturing a pacifier according to the present invention, comprising forming the pacifier using a molding process.

Preferably, the pacifier is formed by a two-step molding process. Preferably, the method comprises using blow molding to form the nipple from a softer plastic material in a first step and molding onto the nipple the nipple supporting surface of a harder plastic material.

The pacifier may alternatively be formed as a single piece of material.

The inventors have realized that a molding process is a cheap and reliable method for forming the pacifier of the present invention. In forming the pacifier from a single piece of apparatus, a more robust and durable pacifier is realized as there are no moving parts or joints to fatigue.

Preferably, means is provided for suspending a pacifier. The suspending means preferably comprises a hook and a receptacle attached to the hook, the receptacle being arranged to receive and releasably interlock with a nipple of the pacifier.

Preferably, the apparatus for suspending a pacifier is a single piece of material.

The inventors have realized that by employing such an apparatus, pacifiers may be easily hung from desired points in an appropriate environment. For example, a pacifier may be sold with such an apparatus, the apparatus serving to store the pacifier both in the store, and after it has been purchased, in the home. When combined with the stackable pacifiers as described in this patent application, the apparatus facilitates the display and storage of a plurality of pacifiers, simply by attaching the apparatus to the uppermost pacifier of the stack, and then hanging the plurality in a desired location via use of the hook.

### DESCRIPTION OF THE DRAWINGS

Embodiments of the present invention will now be described, by way of example only, with reference to the accompanying figures, in which:

FIGS. 1a to 1c are schematic views of a pacifier according to an embodiment of the present invention;

FIG. 2 is a schematic view of a plurality of the pacifiers of FIG. 1, stacked and interlocked;

FIG. 3 is a perspective view of a plurality of pacifiers according to an embodiment of the present invention, stacked and interlocked;

FIGS. 4a to 4c are schematic views of an apparatus for hanging a pacifier according to an embodiment of the present invention;

FIGS. 5a and 5b are schematic views of the apparatus for hanging a pacifier of FIG. 4, in conjunction with the pacifier of FIG. 1 and the stack of pacifiers of FIG. 2;

FIG. 6 is a perspective view of an apparatus for hanging a pacifier in conjunction with a plurality of stacked pacifiers, according to an embodiment of the present invention;

FIGS. 7a to 7b are schematic views of a pacifier according to an embodiment of the present invention;

FIGS. 8a and 8b are schematic views of a plurality of the pacifiers of FIG. 7, interlocked;

FIGS. 9a and 9b are perspective views of a plurality of pacifiers according to an embodiment of the present invention, interlocked;

FIGS. 10a to 10c are schematic views of a pacifier according to an embodiment of the present invention;

FIGS. 11a and 11b are schematic views of a plurality of the pacifiers of FIG. 10, interlocked; and

FIG. 12 is a perspective view of a plurality of pacifiers according to an embodiment of the present invention, interlocked.

### DETAILED DESCRIPTION OF THE PREFERRED EMBODIMENT

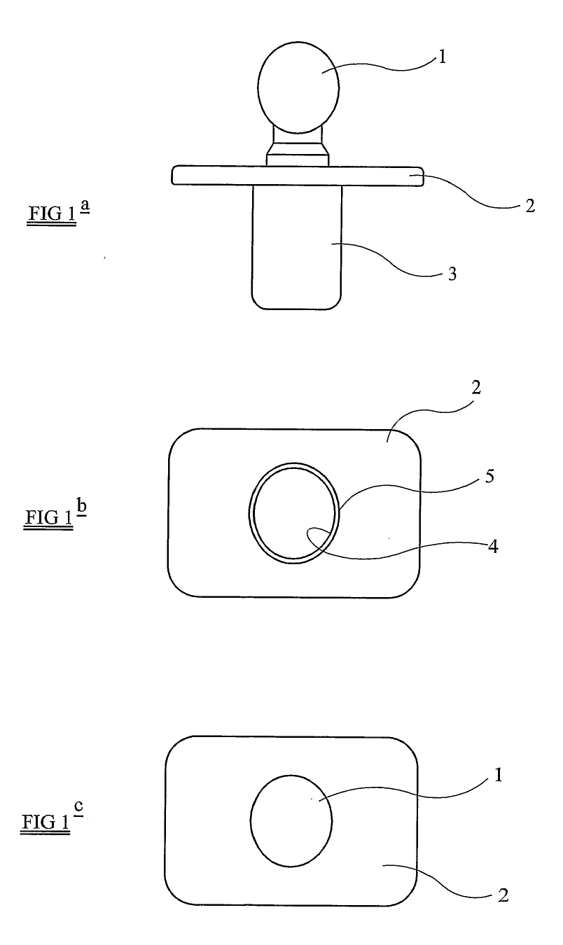

FIGS. 1a to 1c show a pacifier according to an embodiment of the present invention in side view, bottom view, and top plan view, respectively. The pacifier comprises a nipple 1, a supporting surface 2 and a receptacle 3. The nipple protrudes from the center of a first side of the supporting surface 2. The receptacle 3 protrudes from the center of a second, opposite side of the supporting surface 2. The receptacle 3 is substantially cylindrical in shape. The supporting surface 2 is substantially planar, and is rectangular in cross-section with rounded edges.

The nipple 1 is relatively flexible, such that an infant finds the nipple comfortable to suck on. The supporting surface 2 is relatively rigid, and provides a structure from which the nipple 1 and the receptacle 3 protrude.

As well as supporting the nipple 1 and the receptacle 3, the supporting surface 2 also serves to prevent an infant from swallowing the pacifier, and also functions as a grip for an infant using the pacifier. The supporting surface 2 may also serve as a biting area or teething tool for the infant. The receptacle 3 comprises an inner receptacle surface 4 and an outer receptacle surface 5, and is arranged to receive and releasably interlock with the nipple 1 of a like pacifier. A like pacifier is a pacifier substantially the same as the pacifier of FIG. 1. In this embodiment, a releasable interlock is defined as providing a grip or lock that requires a force for it to be overcome, i.e. to separate interlocked pacifiers. For example, this may be a friction fit or a push fit, or the like.

The dimensions of the inner receptacle surface 4 correspond substantially to the outer dimensions of the nipple of a like pacifier, for example, the nipple 1 of the present pacifier. By having an inner receptacle surface 4 with these dimensions, a releasable interlock may be formed between the receptacle 3 of a first pacifier and the nipple of a like pacifier.

The pacifier is formed by a two-stage molding process. The nipple 1 is formed by blow molding from a softer plastic material in a first stage, and the supporting surface and receptacle, which may be made of a harder plastic material, are molded onto the nipple. It may alternatively be possible to mold the pacifier in one piece.

No additional or separate apparatus is required to provide the interlock between like pacifiers. For example, no string or ribbon is required. Additionally, no moving parts are required to provide the interlock.

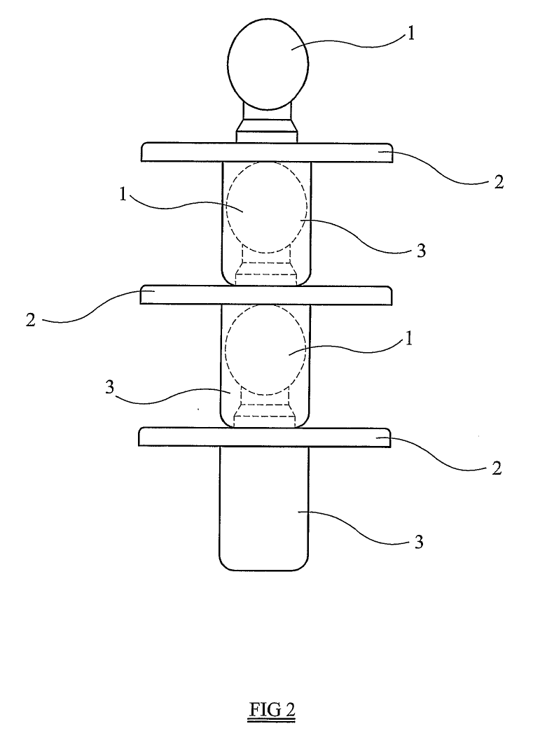

The pacifier of FIG. 1 may be used in a conventional manner. For example, an infant may suck the nipple 1 of the pacifier in order to provide comfort. However, the advantages of the pacifier of FIG. 1 are further evident in FIG. 2.

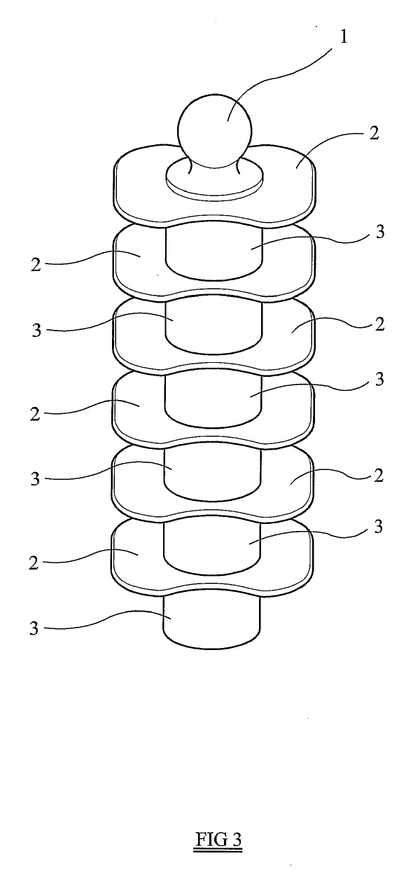

FIG. 2 illustrates a plurality of like pacifiers stacked on top of one another. To stack the pacifiers, the nipple 1 of a first pacifier is placed into the receptacle 3 of a like pacifier. As the dimensions of the inner receptacle surface 4 correspond to the outer dimensions of the nipple 1, the receptacle 3 receives and releasably interlocks with the nipple 1. The interlock is a “push-fit” arrangement. A nipple 1 of a first pacifier that is interlocked with a receptacle 3 of a like pacifier is completely enveloped by the receptacle 3. This has the advantage of minimizing or reducing exposure of the nipple 1 to the environment, thereby reducing or preventing the buildup of chemical and particulate contaminants on the surface of the nipple 1. Enveloping the nipple 1 increases the hygiene of the nipple 1, and may decrease the time spent on cleaning the nipple 1 prior to use by an infant. A plurality of interlocked pacifiers according to an embodiment of the present invention is shown in perspective in FIG. 3.

As the pacifiers are releasably interlocked, the pacifiers may be easily stored away and presented. As the pacifiers are interlocked, it is not necessary to hold or support all of the pacifiers within a stack when, for example, moving the stack. As long as the number of pacifiers in the stack is not excessive, so as to overcome the frictional forces introduced in the push-fit arrangement, the stack may be lifted, carried about, or suspended by lifting, carrying, or suspension of the uppermost pacifier in the stack.

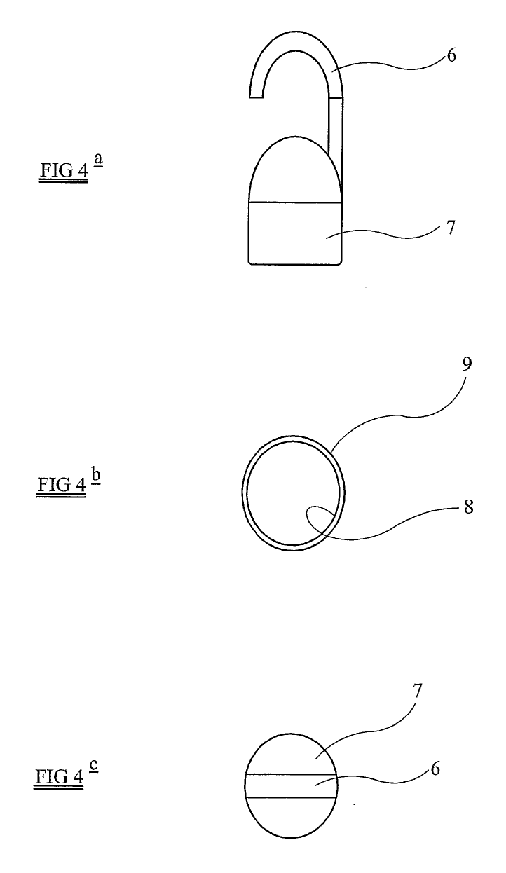

Suspension, lifting or carrying of a stack of pacifiers may be facilitated by the use of additional apparatus in accordance with an embodiment of the present invention, for example a hook attachable to the uppermost pacifier. FIG. 4 illustrates such apparatus.

FIG. 4 shows an apparatus for suspending a pacifier in side view, bottom view, and top plan view, respectively. The suspension apparatus comprises a hook 6 attached to a receptacle 7. The receptacle of the suspension apparatus 7 is substantially identical to the receptacle 3 of the pacifier of FIGS. 1 through 3.

The receptacle 7 comprises an inner receptacle surface 8 and an outer receptacle surface 9. The receptacle 7 of the suspension apparatus is arranged to receive and releasably interlock with the nipple 1 of a pacifier. In this embodiment, the dimensions of the inner receptacle surface 8 correspond substantially to the outer dimensions of a nipple 1 of a pacifier to be suspended from the apparatus, for example, the nipple 1 of the pacifier of FIG. 1. By having an inner receptacle surface 8 with these dimensions, a releasable interlock may be formed between the receptacle 7 and the nipple 1 of a pacifier.

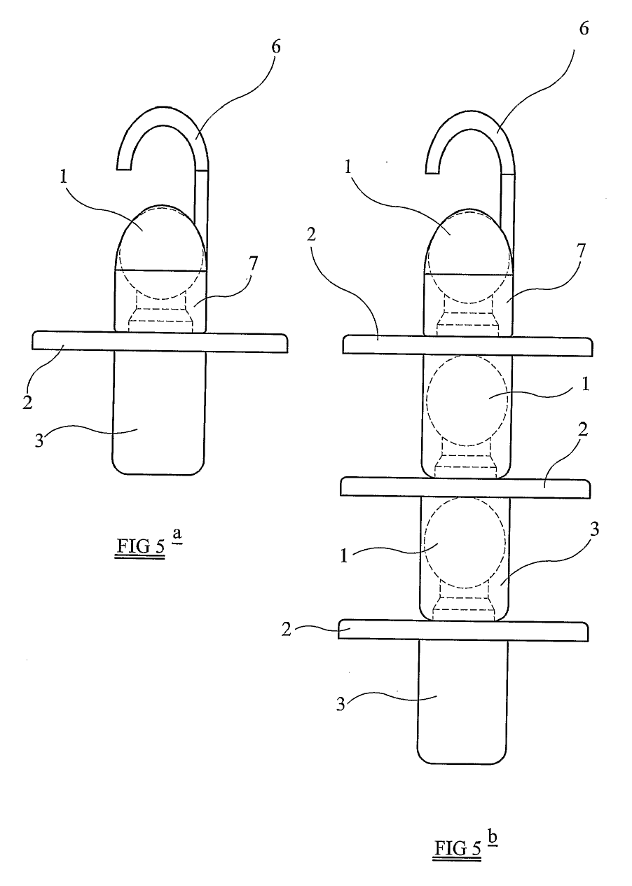

The suspension apparatus may be formed by an injection molding process, such that the hook 6 and the receptacle 7 of the suspension apparatus are formed integrally. FIGS. 5a and 5b show the use of the suspension apparatus of FIG. 4.

In use, the nipple 1 of a pacifier is placed into the receptacle 7 of the suspension apparatus. As the dimensions of the inner receptacle surface 8 correspond to the outer dimensions of the nipple 1, the receptacle 7 receives and releasably interlocks with the nipple 1. The interlock is a “push-fit” arrangement.

A nipple 1 that is interlocked with a receptacle 7 of the suspension apparatus is completely enveloped by the receptacle 7. This has the advantage of minimizing or reducing exposure of the nipple 1 to the environment, thereby reducing or preventing the buildup of chemical and particulate contaminants on the surface of the nipple 1. Enveloping the nipple 1 increases the hygiene of the nipple 1, and may decrease the time spent on cleaning the nipple 1 prior to use by an infant.

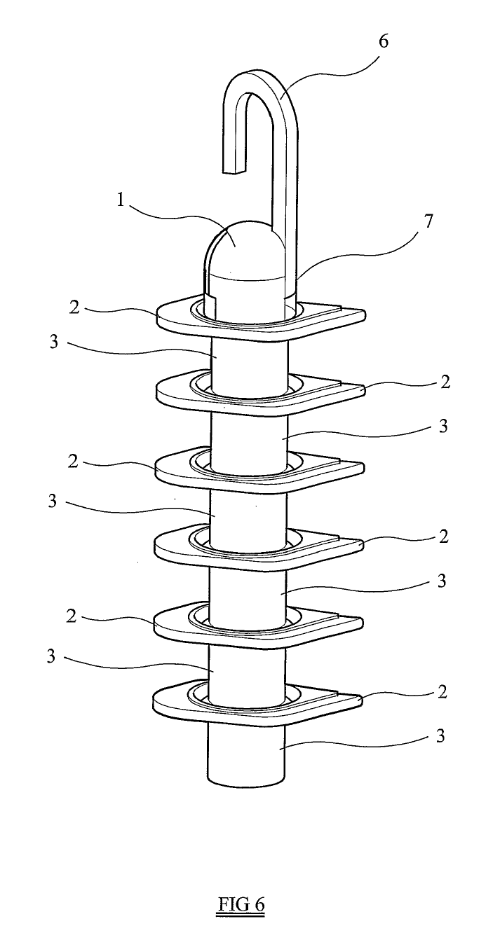

It will be appreciated that the apparatus for suspending a pacifier may be used in conjunction with a single pacifier (as illustrated in FIG. 5a), or with a plurality of interconnected pacifiers, as illustrated in FIG. 5b. FIG. 6 shows stacked pacifiers and suspension apparatus, according to an embodiment of the present invention, in perspective.

It will be appreciated that in all of the embodiments described thus far, the releasable interlock can be formed in a number of other ways. Functionally, the releasable interlock need only have the feature of the receptacle maintaining a “grip” on the nipple 1 that is to be cooperated with, i.e. so that a reasonable degree of force is required remove the nipple 1 from the receptacle 7. The ‘“grip” or “releasable interlock” may, as described above, be a push-fit arrangement. The push-fit may be formed by making the inner receptacle surface 8 of the receptacle 7 tapered. Alternatively, the inner receptacle surface 8 may have ridges or protrusions, which may interact with corresponding ridges or protrusions on the nipple 1 to form the interlock.

It will be further appreciated that the outer receptacle surfaces 5 and 9 may be shaped so as to fit comfortably in the hand of an infant, or caregiver thereof, i.e. forming an ergonomic grip. The outer receptacle surfaces 5 and 9 may also be textured to aid the grip of the pacifier or the suspension apparatus. For example, the outer receptacle surfaces 5 and 9 may form a series of ridges or protrusions to facilitate the grip of the pacifier or the suspension apparatus.

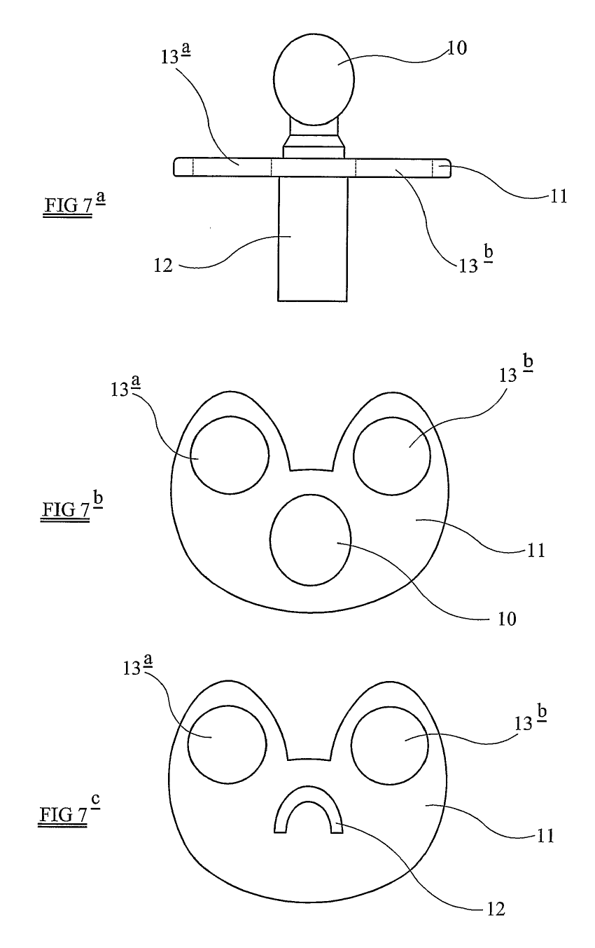

FIGS. 7a to 7c show a pacifier according to another embodiment of the present invention, in side view, top plan view, and bottom view, respectively. The pacifier comprises a nipple 10, a supporting surface 11, and a guide element 12. The nipple 10 protrudes from a first side of a main section of the supporting surface 11. The guide element 12 is an arcuate tongue of material that protrudes from a second, opposite side of the main section of the supporting surface 11. The supporting surface 11 is substantially planar.

The supporting surface 11 comprises two lobes, integral to the main section. Each of the lobes comprises a circular aperture 13a or 13b. Thus, the apertures 13a and 13b are remote from the nipple 10, and are on the periphery of the pacifier.

Each lobe aperture 13a and 13b is arranged to receive and releasably interlock with the nipple of a like pacifier; for example the nipple 10 of another pacifier that is substantially the same as the pacifier of FIG. 7. At least one diameter of each of the apertures 13a and 13b is slightly less than a diameter of the nipple 10 of a like pacifier. By incorporating such a restriction, a push-fit arrangement between either of the apertures 13a and 13b and the nipple 10 of a like pacifier can be established. The apertures 13a and 13b and the tongue 12 are shaped such that the tongue 12 may be inserted into one of the apertures 13a and 13b. The nipple 10, the supporting surface 11, and the tongue 12 are formed integrally and as described above in relation to the pacifier of FIG. 1. Specifically, the pacifier is formed by injection molding of a plastic material.

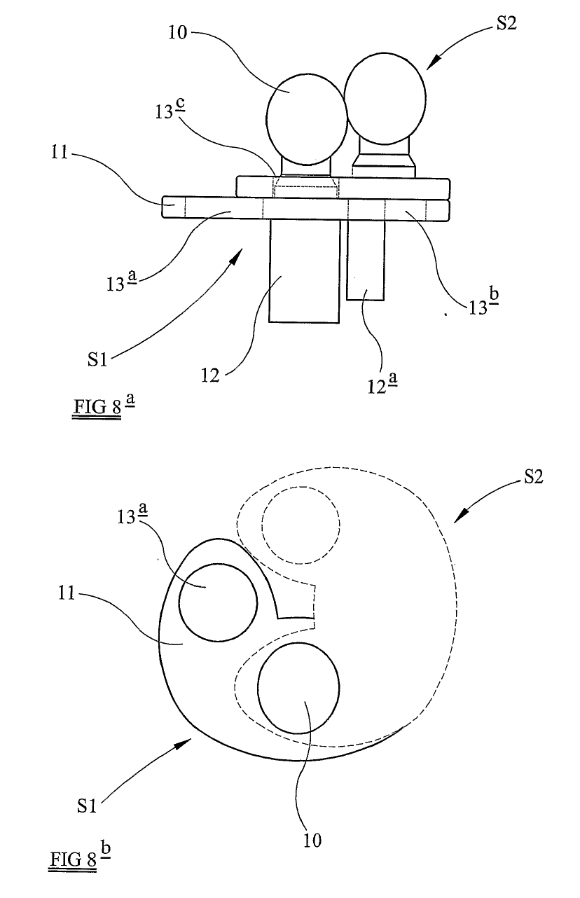

FIGS. 8a and 8b show two interlocked pacifiers S1 and S2, which are shown in a side view and a top plan view, respectively. In FIG. 8b, one of the pacifiers has been drawn in outline to distinguish it from the other. In use, the nipple 10 of a first pacifier S1 is pushed through an aperture 13c of a second pacifier S2. The nipple 10 and/or the aperture 13c are slightly (and temporarily) deformed as the nipple 10 passes through the aperture 13c. Once the nipple 10 has been pushed through the aperture 13c, the aperture 13c and/or the nipple 10 return to an un-deformed shape. In order to remove the nipple 10 from the aperture 13c, the same deformation, and corresponding force, is required, i.e., a push-fit arrangement is formed, and is utilized to releasably interlock the pacifiers S1 and S2.

As the nipple 10 of the first pacifier S1 is pushed through the aperture 13c of the second pacifier S2, a tongue 12a of the second pacifier S2 is simultaneously passed through the aperture 13b of the first pacifier S1. The nipple 10 and the aperture 13c have a push-fit arrangement that ensures that the first and second pacifiers S1 and S2 are releasably interlocked, whereas the passing of the tongue 12a through the aperture 13b enforces a relative orientation of the first and second pacifiers S1 and S2. Such enforced orientation, together with strategic placement of the apertures 13a, 13b, and 13c of the pacifiers, can allow a plurality of pacifiers to be interlocked in a space-saving manner.

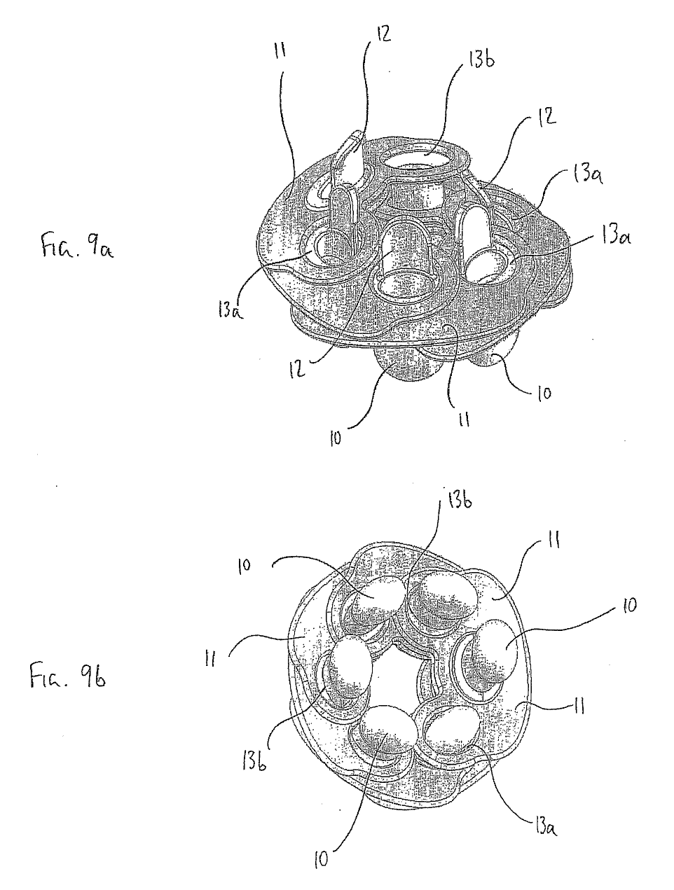

FIGS. 9a and 9b show a plurality of interlocked pacifiers according to an embodiment of the present invention, in perspective. The apertures of each (like) pacifier have been positioned such that the plurality of pacifiers may form an interlocked ring. This allows for the efficient storage of a plurality of pacifiers.

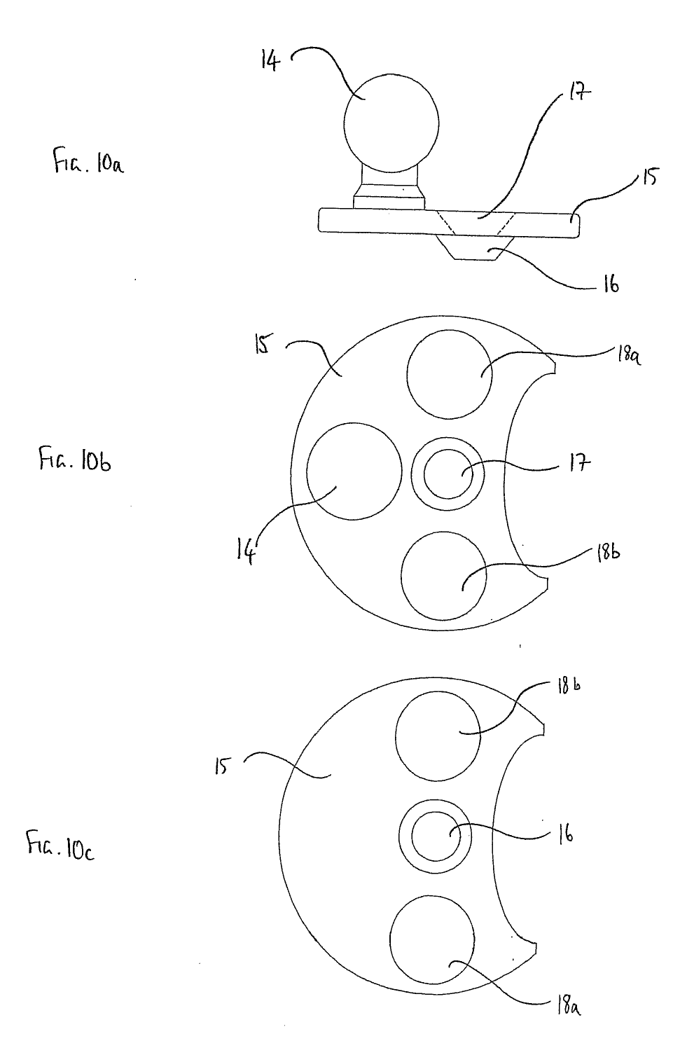

FIGS. 10a to 10c show a pacifier according to yet another embodiment of the present invention in side view, top plan view, and bottom view, respectively. The pacifier comprises a nipple 14 and a supporting surface 15. The nipple 14 protrudes from a periphery of a first side of the supporting surface 15. The supporting surface 15 is substantially disc shaped, but has a circumference that has an indent diametrically opposed to the nipple 14. The supporting surface 15 is shaped so as to form a guide element 16 and a guide recess 17.

The guide element 16 is formed in the center of a second, opposite side of the supporting surface 15, and is a truncated cone. The guide recess 17 is formed in the center of the first side of the supporting surface 15. The outer dimensions of the guide element 16 correspond substantially to the inner dimensions of the guide recess 17, such that the guide element 16 of the pacifier of FIG. 10 may be received by the guide recess of a like pacifier, for example the guide recess 17 of a pacifier that is substantially the same as the pacifier shown in FIG. 10.

The supporting surface 15 further comprises circular apertures 18a and 18b for receiving the nipple 14 of a like pacifier, for example the nipple 14 of a pacifier that is substantially the same as the pacifier shown in FIG. 10. The apertures 18a and 18b are located on the periphery of the supporting surface 15. Each of apertures 18a and 18b is arranged to receive and releasably interlock with the nipple 14 of a like pacifier. At least one diameter of the apertures 18a and 18b is slightly less than a diameter of the nipple 14 of a like pacifier. By incorporating such a restriction, a push-fit arrangement between one of the apertures 18a and 18b and nipple 14 of a like pacifier can be established.

The nipple 14, the supporting surface 15, and the apertures 18a and 18b are formed integrally and as described above in relation to the pacifier of FIG. 1. Specifically, the pacifier is formed by injection molding of a plastic material.

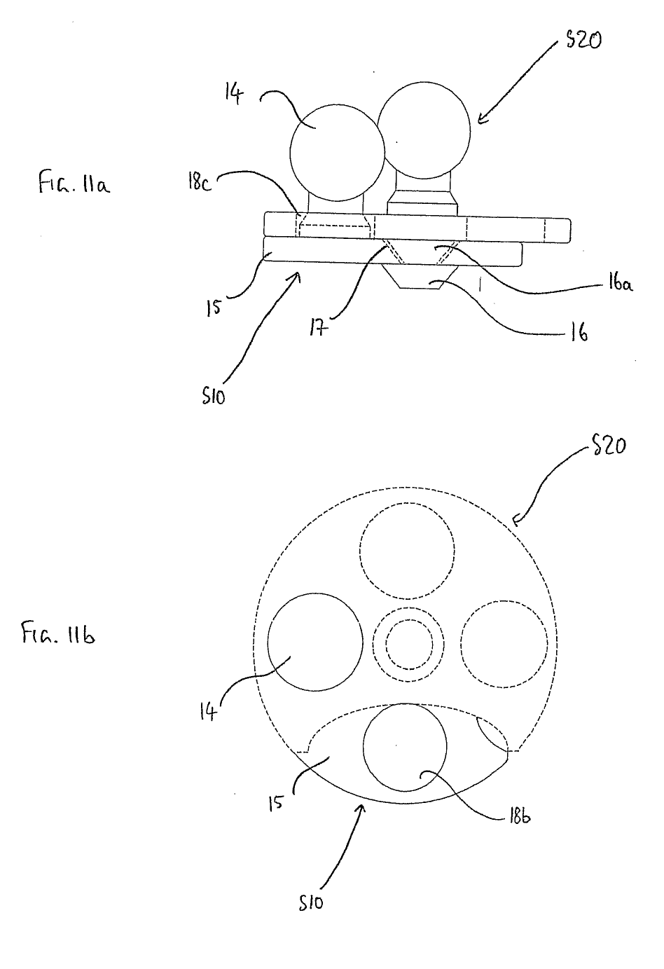

FIGS. 11a and 11b show two interlocked pacifiers S10 and S20 in a side view and a top plan view, respectively. In FIG. 11b, one of the pacifiers S20 has been drawn in outline to distinguish it from the other pacifier S10. In use, the nipple 14 of a first pacifier S10 is pushed through the aperture 18c of a second pacifier S20. The nipple 14 and/or the aperture 18c are slightly (and temporarily) deformed as the nipple 14 passes through the aperture 18c. Once the nipple 14 has been pushed through the aperture 18c, the aperture 18c and/or the nipple 14 return to an un-deformed shape. In order to remove the nipple 14 from the aperture 13c, the same deformation, and corresponding force, is required—i.e. a push-fit arrangement is formed, and is utilized to interlock the pacifiers S10 and S20.

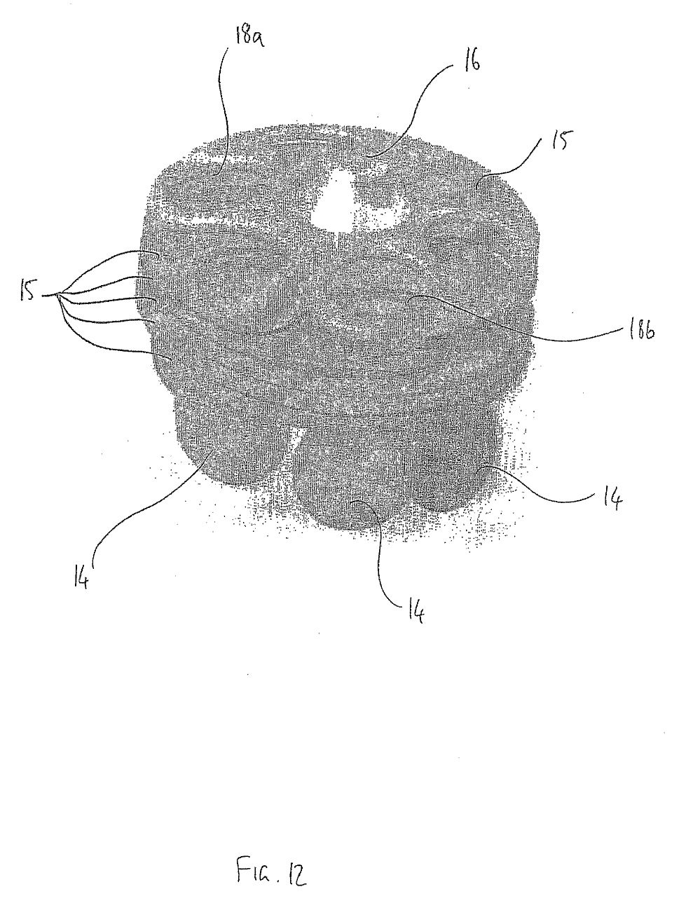

As the nipple 14 of the first pacifier S10 is pushed through the aperture 18c of the second pacifier S20, a guide element 16a of the second pacifier S20 is located in the guide recess 17 of the first pacifier S10. The nipple 14 and the aperture 18c push-fit arrangement ensures that the first and second pacifiers S10 and S20 are releasably interlocked, whereas the location of the guide element 16a in the recess 17 enforces a relative orientation of the first and second pacifiers S10 and S20. Such enforced orientation, together with strategic placement of the apertures 13a, 13b, and 13c of the pacifiers, can allow a plurality of pacifiers to be interlocked in a space-saving manner, as can be seen in FIG. 12.

FIG. 12 shows a plurality of interlocked pacifiers according to an embodiment of the present invention, in perspective. The apertures of each (like) pacifier are shaped and positioned such that six (or more) pacifiers may be interlocked in an efficient manner.

Although not essential, FIGS. 11b and 12 show that the aforementioned indent in the circumference of the supporting surface 15 allows easier access for pushing a nipple 14 through an aperture of another interlocked pacifier, for example an aperture 18d of the second pacifier S20 of FIG. 11b.

It will be appreciated that it is not essential that the nipple 14 and the apertures 18a and 18b are on the periphery of the supporting surface 15. For example, the nipple 14 and the apertures 18a and 18b need only be disposed about the center of the supporting surface 15.

It will be appreciated that the locations of the guide element 16 and the guide recess 17 may be reversed, while still performing the same function. For example, the guide element 16 may be formed in the center of the first side of the supporting surface 15, whereas the guide recess 17 may be formed in the center of the second side of the supporting surface 15. Although not essential, having the guide element 16 and the guide recess 17 in the center of the supporting surface allows easy location of the guide element 16 of one pacifier into the guide recess 17 of a like pacifier.

It will be appreciated that the above-mentioned embodiments of the present invention have been given as examples only. It will be appreciated to one of ordinary skill in the art that various modifications may be made to the above-described embodiments without detracting from the invention, which is defined by the claims.

In the embodiments described above, a releasable interlock is formed by various friction fits or push-fit. It will be appreciated that any interlock that is readily releasable may be suitable. For example, the receptacle may be tapered to receive the nipple. In other embodiments, the nipple and the receptacle may have corresponding protrusions and recesses, such that a snap-fit may arrangement may be formed. Push-fits and snap-fits are preferable, since they have no moving parts and may easily be formed in molds.

It will be appreciated that in embodiments of the present invention utilizing apertures, by locating the apertures in specific places, different numbers of pacifiers can be interlocked together.

All of the pacifiers previously described are formed as a single pieces using injection molding techniques. However, it will be appreciated that other techniques are suitable. For example, the pacifier may be formed from individual elements, which are glued or fusion bonded to each other. A single piece molding process is preferable, since such a process is simple and cost-effective. A single piece pacifier is also more robust.

It will be appreciated that in all of the above-mentioned pacifiers, the function of the nipple is conventional, i.e. to serve as a dummy nipple for an infant. However, the shape of the nipple may differ according the desired releasable interlock that is to be employed between like pacifiers. The nipple may be non-symmetrical so that a push-fit may be established with a symmetrical aperture or receptacle. For example, a nipple with an elliptical cross-section may be used in conjunction with a circular aperture, the major axis of the ellipse having a larger radius than that of the circular aperture.

The pacifier may comprise air holes to allow an infant who accidentally swallows the pacifier to continue to breathe. The apertures of certain embodiments of the present invention may serve as these air holes.

Surfaces of the pacifier not forming the nipple (non-nipple surfaces) may have functions not described in all of the above embodiments. For example, some or all non-nipple surfaces may be textured or shaped so as to form a grip for a user of the pacifier. The supporting surface may form a teething region for the infant.

It will be appreciated that, due to the relatively compact storage afforded to the interlockable pacifiers of the present invention, much simpler and smaller packaging is realizable. The interlocked pacifiers of FIGS. 3, 6, 9, and 12 may be packaged in a snugly fitting container. For example, the interlocked pacifiers of FIG. 12 may be packaged in a plastic cylinder having a cross-section with dimensions corresponding to, but slightly exceeding, those of the supporting surfaces of the pacifiers. Such packaging would have little wasted space. In contrast, in order to package a plurality of prior art pacifiers, a specific molding is often required, or else a large portion of the space within the packaging is wasted. Such a specific molding may be less efficient to produce, and is not as reusable as a simply shaped package.

Although the foregoing description of the pacifiers of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

1. A pacifier, comprising:
a nipple; and
a nipple supporting surface, the nipple being attached to and extending from a first side of the nipple supporting surface;
wherein the pacifier is arranged and configured to releasably interlock with at least one like pacifier.

2. A pacifier as defined in claim 1, further comprising:
a receptacle for receiving the nipple of a like pacifier.

3. A pacifier as defined in claim 2, wherein the receptacle extends from a second side of the nipple supporting surface, the second side being on an opposite side of the nipple supporting surface to the first side.

4. A pacifier as defined in claim 2, wherein the receptacle defines an inner receptacle surface arranged and configured to receive the nipple of the like pacifier.

5. A pacifier as defined in claim 4, wherein the inner receptacle surface is arranged and configured to provide a push-fit arrangement with the nipple of the like pacifier.

6. A pacifier as defined in claim 4, wherein the inner receptacle surface has dimensions corresponding substantially to the outer dimensions of the nipple of the like pacifier.

7. A pacifier as defined in claim 4, wherein the inner receptacle surface is tapered.

8. A pacifier as defined in claim 4, wherein the inner receptacle surface is shaped such that the inner receptacle surface is arranged and configured to completely envelope the nipple of the like pacifier when interlocked therewith.

9. A pacifier as defined in claim 1, wherein the nipple supporting surface comprises:
at least one aperture arranged to receive a nipple of a like pacifier.

10. A pacifier as defined in claim 9, wherein the nipple is located on the periphery of and depends from a first side of the nipple supporting surface.

11. A pacifier as defined in claim 9, wherein the at least one aperture is located adjacent the periphery of the nipple supporting surface.

12. A pacifier as defined in claim 9, wherein the pacifier further comprises:
a guide element arranged and configured to ensure a specific relative orientation of the pacifier and the like pacifier when releasably interlocked therewith.

13. A pacifier as defined in claim 12, wherein the guide element extends from a second side of the nipple supporting surface, the second side being on an opposite side of the nipple supporting surface to the first side.

14. A pacifier as defined in claim 12, wherein the guide element is located substantially in the center of the nipple supporting surface.

15. A pacifier as defined in claim 12, wherein the pacifier further comprises:
a guide recess arranged to receive a the guide element of the like pacifier.

16. A pacifier as defined in claim 15, wherein the guide recess is formed in the first side of the nipple supporting surface.

17. A pacifier as defined in claim 15, wherein the guide recess is located in the center of the nipple supporting surface.

18. A pacifier as defined in claim 15, wherein the guide element has outer dimensions that substantially correspond to the inner dimensions of the guide recess.

19. A pacifier as defined in claim 12, wherein the at least one aperture is shaped to receive the guide element of the like pacifier.

20. A pacifier as defined in claim 1, wherein the nipple supporting surface is substantially disc-shaped.

21. A pacifier as defined in claim 1, wherein the nipple supporting surface is shaped such that, in a location diametrically opposed to the nipple, there is an indent in the circumference of the supporting surface.

22. A pacifier as defined in claim 1, further comprising:
means for suspending the pacifier.

23. A pacifier as defined in claim 22, further wherein the means for suspending the pacifier comprises:
a hook; and
a receptacle attached to the hook, the receptacle being arranged to receive and releasably interlock with the nipple of the pacifier.

24. A pacifier as defined in claim 1, wherein said pacifier is manufactured using a molding process.

25. A pacifier as defined in claim 24, wherein the pacifier is formed by a two-step molding process.

26. A pacifier as defined in claim 24, wherein the first of the two steps is to blow mold the nipple component.

27-29. (canceled)

30. A pacifier, comprising:
a substantially flat supporting surface having a first side and a second side that is opposite the first side;
a nipple that is attached to and extends outwardly from the first side of the supporting surface; and
an engagement element for receiving a nipple from a second pacifier therein, the engagement element being accessible from the second side of the supporting surface to allow the second pacifier to be removably interlocked with said pacifier.

31. A pacifier, comprising:
a supporting surface having a first side and a second side that is opposite the first side;
a nipple that is attached to and extends outwardly from the first side of the supporting surface; and
an engagement element for receiving a nipple from a second pacifier therein, the engagement element being accessible from the second side of the supporting surface and being arranged and configured to accommodate and removably retain the nipple of the second pacifier therein, thereby allowing the second pacifier to be removably interlocked with said pacifier;
wherein the supporting surface, the nipple, and the engagement element are manufactured together in a unitary construction.
